(19) United States
(12) Patent Application Publication
(10) Pub. No.: US 2011/0060674 A1
(43) Pub. Date: Mar. 10, 2011

(54) COMPUTER-IMPLEMENTED GLOBAL CURRENCY DETERMINATION

(75) Inventor: Edward Michael King, London (GB)

(73) Assignee: WDX ORGANISATION, London (GB)

(21) Appl. No.: 12/557,419

(22) Filed: Sep. 10, 2009

(51) Int. Cl. G06Q 40/00

(52) U.S. Cl. 705/37; 705/35

(57) ABSTRACT

Embodiments of the present invention are directed at least in part to a computer-implemented method for determining the value of a global currency. Data indicative of a Gross Domestic Product (GDP) value of each of a plurality of countries is used to select a plurality of countries on the basis of a predetermined criterion, and then relative weightings of the selected countries are evaluated on the basis of their respective GDP values. The global currency is evaluated by combining the evaluated relative weightings with currency values associated with the selected countries.

### BACKGROUND OF THE INVENTION

1. Field of the Invention

This application relates to a system and method for determining the value of a global currency basket on the basis of Gross Domestic Product (GDP) values.

2. Description of Related Technology

The use of “baskets”, or groups, of major currencies is known in international trade and finance. Special Drawing Rights (SDR) are used as a unit of account by the International Monetary Fund (IMF), and the values of each chosen currency against the SRD are dependent on the relative importance of that currency in international trade and finance.

Another example of the use of a basket of currencies is the European Currency Unit (ECU), which was used as a unit of account by member states of the European Community (EC) before the introduction of the Euro as a “real” currency.

Such basket currencies are used to set the values of currencies against one another, and are used in international financial transactions.

However, a drawback of such systems is that the selection of countries on whose currency the basket currencies are based is political, being based on the perceived “major” currencies or their role in international finance, and the selection of currencies is then relatively static. For example, the selection of currencies in the SDR basket and their amounts is made by the IMF Executive Board every five years; the SDR is also a relatively small currency basket.

There is therefore a need for a basket currency that is less susceptible to risk and volatility than known systems, and that is objective in its construction.

### SUMMARY OF CERTAIN INVENTIVE ASPECTS

Aspects of the present invention are directed at least in part to a computer-implemented method for determining the value of a global currency as set out in the appended claims. Specifically, data indicative of a Gross Domestic Product (GDP) value of each of a plurality of countries is used to select a plurality of countries on the basis of a predetermined criterion, and then relative weightings of the selected countries are evaluated on the basis of their respective GDP values. The global currency is evaluated by combining the evaluated relative weightings with currency values associated with the selected countries.

These selected countries define a basket of countries to be used in evaluation of the global currency, and by basing the selection of countries (and hence currencies) used in the basket on the relative GDP values of countries, the global currency is evaluated on an entirely objective basis. Any politically motivated choice of the basket currencies is eliminated. Examples of a suitable criterion include a number of countries defining the plurality of countries or a minimum relative GDP weighting as a percentage. Thus the basket can include either a predetermined number of countries (for example, the top twenty), or all countries whose GDP is more than a predetermined threshold percentage of the total GDP of a predetermined number of countries; by updating the GDP values and hence the countries that are considered in calculating the global currency value, the value can be kept up-to-date with changes in exchange rates and released GDP figures.

The computer-implemented method comprises generating currency value data in the form of an exchange rate for currencies associated with each of the selected countries, each exchange rate being normalized against a base currency. A currency weighting is calculated for each currency value according to the GDP value of each selected country, and each normalized exchange rate is multiplied by its respective currency weighting to determine a weighted currency value. The weighted currency values are then summed together to determine the value of the global currency against the base currency.

The advantages of the global currency stem from the fact that it is the first currency basket to reflect as far as is practical the whole of the world's economic activity. These advantages will apply to countries whose output of goods, commodities and services use currencies outside the global currency constituents as well.

The weightings used within the global currency are based on GDP of, for example, twenty constituent countries' economies. Since these countries make up the most of the world output this means that the resulting index of volatility is low (this means it has a “beta” approaching one, indicating low volatility) and is therefore good for risk managers and corporate traders alike. The global currency, as used as any or all of three things—means of exchange, unit of account or store of value—would effectively represent money, despite being a derivative instrument, and the resulting money would become near “whole of class”. This way of defining the global currency is completely different to conventional approaches, for which currency baskets have hitherto been focused on a geographical area or have had a political construct or a mixture of both. Since the global currency is effectively whole of world and avoids focussing on a particular geographical area and/or being determined according to political issues, it provides a means of avoiding wastage of resources in current foreign exchanges in the form of speculative trading. This is beneficial since it can lead to a reduction in overloading of trading resources experienced with conventional basket currencies, these commonly being of the order ten or more times the volume needed for any given physical trade to be completed.

The global currency can be used within a variety of trading activities within the foreign exchange market, for example, in transactions involving spot, forwards, futures, swaps and options. In addition the global currency can be used to price globally traded commodities, such as petroleum products, agricultural products and metals.

According to further aspects of the invention there is provided a distributed computing system for implementing the method steps set out in the appended claims and computer readable medium for storing program instructions which, when executed on a suitable computing device or distributed system, causes the device or distributed system to perform these method steps.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows an overview of a computer system configured to perform the method of one or more embodiments of the invention;

FIG. 2a shows the components of a value calculation process engine of the system;

FIG. 2b shows the method steps performed by the engine of FIG. 2a;

FIG. 3 shows an automated process performed during a value calculation process;

FIG. 4 shows the steps performed during a weighting process;

FIG. 5 shows a manual process carried out by an authorized user at the beginning of a weighting process;

FIG. 6 shows an automated process performed at a scheduled time;

FIGS. 7a and 7b show an example of weighting values before and after, respectively, the values are re-weighted following a change in GDP and exchange rate values; and

FIG. 8 shows an example of a re-calculation of the global currency following a change in the value of the exchange rate of a basket component currency.

### DETAILED DESCRIPTION OF CERTAIN INVENTIVE EMBODIMENTS

A computer-implemented system and method as described below allows the determination of the value of a global currency, referred to hereafter as a Wocu™. The Wocu™ derives its name from the phrase “World Currency Unit”, and is valued by one or more algorithms as described below.

The currencies used to calculate the value of the Wocu™ are derived using data indicative of a Gross Domestic Product (GDP) value of each of a plurality of countries, the currencies of these countries make up a basket and being selected based on their GDP value. In one example, the currencies that are included in the basket are those of the countries whose GDP is within the top twenty GDPs worldwide by value.

In order to provide a consistent measure of GDP values, standard values, typically the figures produced and issued by the International Monetary Fund (IMF), are used. These figures, both actual and projected, are issued bi-annually, in April and September/October, as part of its World Economic Outlook (WEO) forecast.

The GDP values of each country are reviewed once these figures are available, normalized to a base currency such as the US dollar, and a re-weighting of the basket is performed. This means that the member countries, and therefore the currencies, included in the basket will change each year either by the weighting for the currency being adjusted (up or down) or by the currency being promoted into or demoted out of the basket. By basing the selection of countries, and hence currencies, used in the basket on the relative GDP values of countries in this way, any politically motivated choice of the basket currencies is eliminated, providing an objective basis for the calculation of the Wocu™. The relative weightings of the GDP values are then combined with currency values associated with the selected countries so as to evaluate the Wocu™, as described further below.

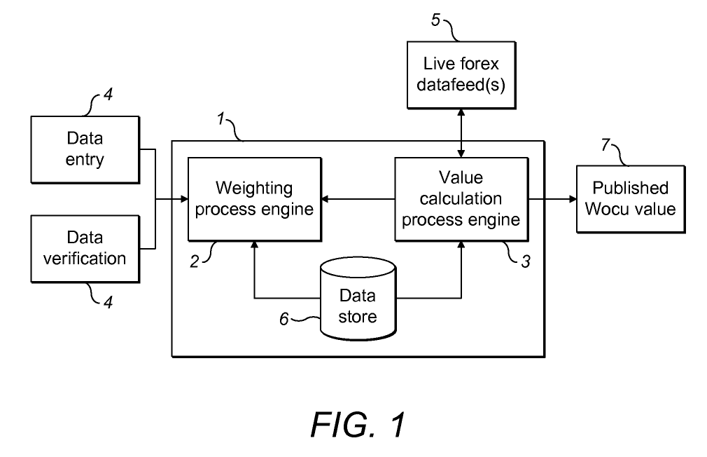

FIG. 1 shows an overview of components of a computer system 1 configured with a computer program or suite of computer programs, referred to collectively as the Wocu™ algorithm, that are calculation engines configured to carry out the evaluation of the Wocu™. The computer system 1 may be a server computer, and in general comprises computer programs configured to carry out a weighting process and a value calculation process by means of respective calculation engines 2, 3. Input data, such as GDP values, and verified data are input into the weighting process from data sources 4, while data input into the value calculation process, such as foreign exchange rate (or “forex” rate) data, can be input in real time via a live data feed 5. A Data Feed Interface can provide one or more programs that integrate data vendors' application programming interfaces (APIs) to enable forex rates to be subscribed to by the value calculation process. The live data feed can be, for example, the Morningstar Interactive data feed or Interactive Data PlusFeed data feed, to provide financial market data updates to the computer system 1. Each of the weighting process and the value calculation process is connected to and can access a data store 6. The value calculation process evaluates the value of the Wocu™ and outputs the resulting value from the computer system, either to a separate system and/or to a display 7, for publication.

The value calculation process, as performed by the value calculation process engine 3, is responsible for the continual calculation of the Wocu™ value, based on the current weighting values provided by the weighting process, and the current forex rate for each currency component of the basket.

The forex data is obtained and stored continually according to the live market data fed into the computer system 1, and every time the data indicates a change in the currency value, the Wocu™ value is re-calculated.

The weighting process, as performed by the weighting process engine 2, is responsible for the calculation of the Wocu™ basket component currency weightings. Re-weighting of the currency value occurs less frequently, typically twice a year in accordance with the IMF's release of updated GDP figures. In accordance with the release of these updated GDP figures, the computer system 1 can be programmed to carry out a re-weighting of the currency values, known as a “re-weighting event”, at pre-scheduled dates and times. The Wocu™ value is then re-evaluated according to the updated countries, their currency weighting and the current forex rate.

In one example, the weighting process is executed bi-annually at 16:00 UTC on the third Thursdays in May and November, in accordance with the issuance of new GDP figures from the IMF.

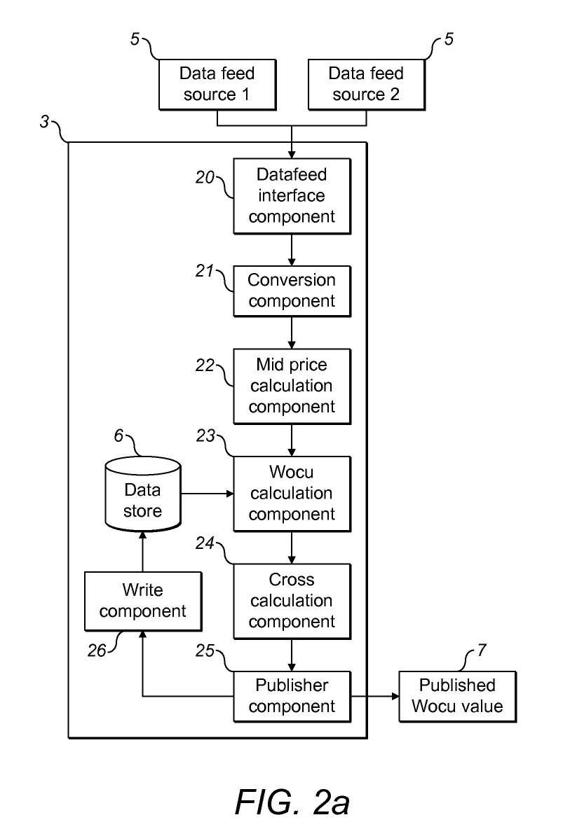

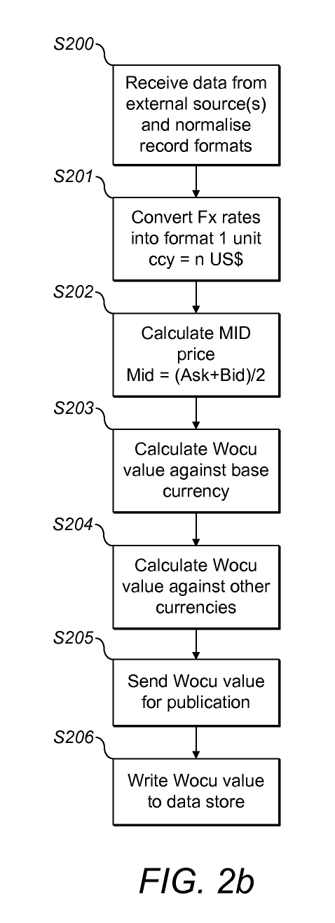

Referring to FIGS. 2a and 2b, the steps of the value calculation process will now be described with reference to software components of the value calculation engine 3. It should be understood that the software components described may be configured separately or as a single software component, or as a different arrangement of components or modules configured to carry out the steps described.

At step S200, currency value data comprising an exchange rate for currencies associated with each of the selected countries is fed into the system from the one or more data feeds 5 via a datafeed interface component 20 of the value calculation process engine 3. The data feeds 5 are typically external sources that provide real time information on forex rates. Each exchange rate is typically received as a rate normalized against the same base currency, such as the US dollar, for example,×Euros=1 US$; where this is not the case, the system ensures that the data is normalized (by the value calculation engine 3) based on a common base currency.

Accordingly at step S201, a conversion component 21 converts the format of the forex rates received to provide a base currency value for one unit of the currency, for example, 1 Euro=n US$.

The currency data received from data feeds 5 is generally received as a selling price (also referred to as an “offer” or “ask” price) and as a buying (or “bid”) price. These prices are provided in the form of the currency price against a unit of base currency (for example, 1 US$). Therefore, at step S202, a mid price calculation component 22 of the calculation engine 3 averages the ask and bid prices to provide a “mid” price for each currency.

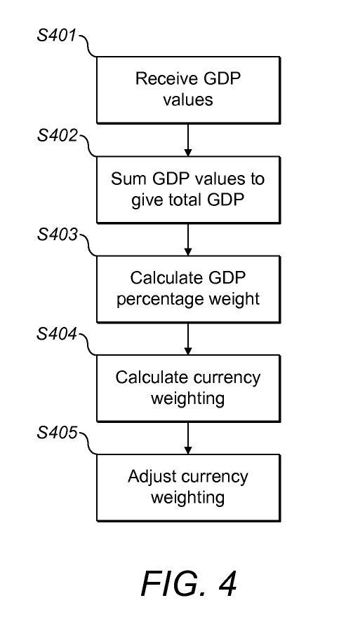

At step 203, a Wocu™ calculation component 23 calculates the Wocu™ value. The component 23 obtains each currency's respective Adjusted Currency Weight (which is calculated by performing an adjustment on the currency weighting, as explained with reference to FIG. 4 below) from the data store 6 and multiplying each normalised currency value (Forex Rate) by its respective currency weighting to determine a weighted currency value, according to the following formula:

Adjusted Currency Weight*Forex Rate=Weighted Currency Value

The weighted currency values are summed to determine the value of the Wocu™ against the base currency.

The value of the Wocu™ can then be calculated by a cross calculation component 24 in step S204, against one or more of the plurality of currencies associated with the selected countries. These values, known as cross values, are calculated on the basis of the Wocu™ value determined by the Wocu™ calculation component 23, using the respective exchange rate of each currency against the base currency. The spot mid forex rate for the respective currency is used, according to the following formula:

Cross value=Wocu™ base currency value/National Currency base

currency value.

The value calculation will be automatically executed and a revised Wocu™ value published as a result of, either: publication of revised weighting values by the weighting process; or receipt of an updated forex rate of any of the component currency's of the current basket.

The results can then be provided to a publisher component 25 in step S205, which is a program that publishes the calculated values to other programs subscribing to those instruments via a suitable API. In step S206, a write component 26 that subscribes to published values, via the publisher, writes the resulting values to the data store 6. This program is, in one example, configured to capture the Wocu™ official value at 16:00 UTC daily, and may be configured to capture this value at other frequencies as may be required.

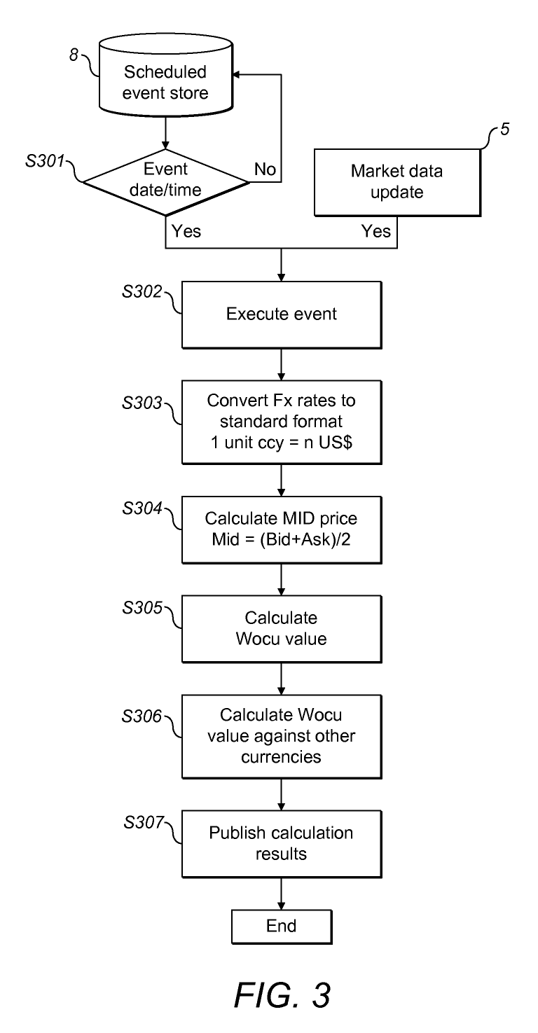

Referring to FIG. 3, in which steps S303-S307 correspond to steps S201-S205 of FIG. 2b, the computer system 1 will constantly monitor both a scheduled event store 8 for a re-weighting event and the real time data feeds 5 for a forex rate update event. The scheduled event store 8 can store a predetermined schedule of dates and times which, when reached (step S301), trigger an update of the currency weightings, and hence the Wocu™ value. The result of the execution of an update (step S302) will be a revised calculation of the Wocu™ value according to steps S303-S307 (as described with respect to steps S201-S205 of FIG. 2) and this re-calculated value is then published to any downstream subscribing applications, such as a browser.

The above process is entirely automated and is executed by the computer system 1 as a result of an update event being received.

Referring to FIG. 4, the weighting process will now be described. A Graphical User Interface (GUI) enables authorized users to enter the current GDP values, in the base currency (in this example US$), for a predetermined number, in this example 20, countries with the highest values, and to enter a date of execution of the re-weighting process as necessary, which as mentioned above may be in line with a predetermined schedule entered into the computer system 1 in advance. The GUI also enables a second authorized user to verify the data entered and authorize the execution of the weighting process. The verified and authorized data is stored in the data store 6.

In step S401, the GDP values are received by the calculation engine 2 that performs the weighting process. In step S402, the GDP values of the selected countries are summed to provide a Total GDP value. A GDP Percentage Weight of the total GDP value is then determined in step S403 for each selected country's GDP value:

Country GDP/Total GDP=GDP Percentage Weight.

This GDP Percentage Weight is then converted in step S404 from a value based on the base currency into respective currency weightings based on the national currency of each selected country (the forex rates are provided via the value calculation process in real time as the program executes, as explained above):

GDP Percentage Weight/Forex Rate=Currency Weight.

The calculated currency weighting can then be adjusted, in step S405, based on an adjustment value to provide an Adjusted Currency Weight:

Adjusted Currency Weight=Currency Weight*Adjustment Value.

The adjustment value corresponds to a predetermined value of the Wocu™ against the base currency. There are two methods by which this value is provided:

1) Initial Value—an initial value is only used once the very first time the weighting program is executed and the value is read by the program from a configuration file. In effect, this value will be the Wocu™ forex rate (that is, the Wocu™ value against one unit of the base currency) as determined by the first execution of the Wocu™ Algorithm; or

2) Re-Weighting Value—thereafter whenever the weighting program is executed (for example, bi-annually) the adjustment value utilised is read from the computer system 1 data store 6 and is the official daily forex rate for the Wocu™, as determined by the Wocu™ Algorithm at, for example, 16:00 UTC daily. The use of this value ensures that when the weighting program is executed there is no jump upwards or downwards in the Wocu™ value.

Once the weighting process has executed, the derived Adjusted Currency Weights are sent to the value calculation process engine 3 (to be used in the re-calculation of the Wocu™ value) and trigger the value calculation process in the manner described above. The Adjusted Currency Weights are also written to the data store 6 to provide an audit trail of events.

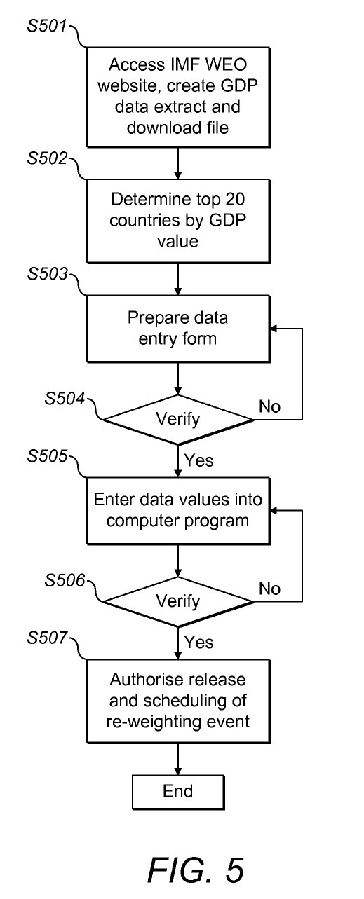

FIG. 5 shows a typically manual process carried out by an authorized user bi-annually to coincide with the publication of the revised IMF World Economic Outlook (WEO) GDP figures. It should be understood that the computer system 1 may be configured in accordance with an external system to perform these steps automatically.

In step S501, the IMF WEO website is accessed and the GDP figures are downloaded. The countries having the highest GDP value (when these values are normalized to a base currency) are then determined in step S502. In one example, the top 20 countries are selected, however it should be understood that this number can be more or less depending on the values; for example, it may not be considered necessary to include countries whose GDP Percentage Weight of the Total GDP is below a threshold percentage, for example, 2% GDP. The relevant country and GDP data is prepared in a specified format in step S503 and verified in step S504. The verification involves a second manual input, and the computer then compares the values entered and accepts the values if they are identical; if they are not identical the input data is rejected. The data is then entered into the computer program associated with the weighting process in step S505, and verified in step S506. Once the revised GDP values have been entered and verified the weighting adjustment data is released for automatic executions and the revised weighting values for each currency will be released into the public domain in step S507.

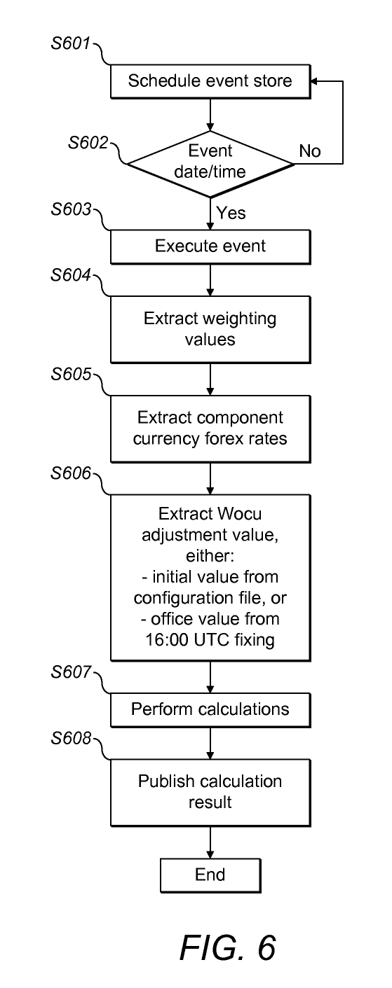

FIG. 6 shows an automated process that is executed by the computer system 1 at the pre-scheduled date and time, for example at the time of the re-weighting event. The computer system 1 constantly monitors (step S601) the data store 6 and automatically executes (step S603) each scheduled re-weighting when the event date/time is reached (step S602). No manual intervention is required once the event has been scheduled.

In steps S604-S606, the weightings, component currency forex rates and adjustment value, respectively, are retrieved. The calculation of the Wocu™ is performed (step S607) by the Wocu™ calculation component 23 as described above, and the Wocu™ value is published.

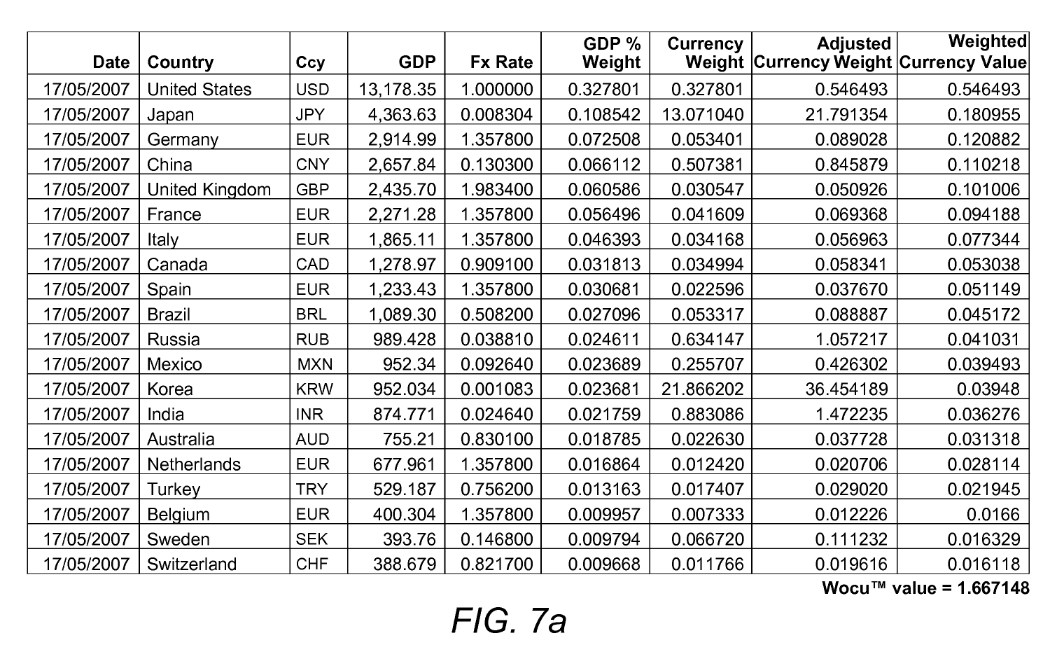

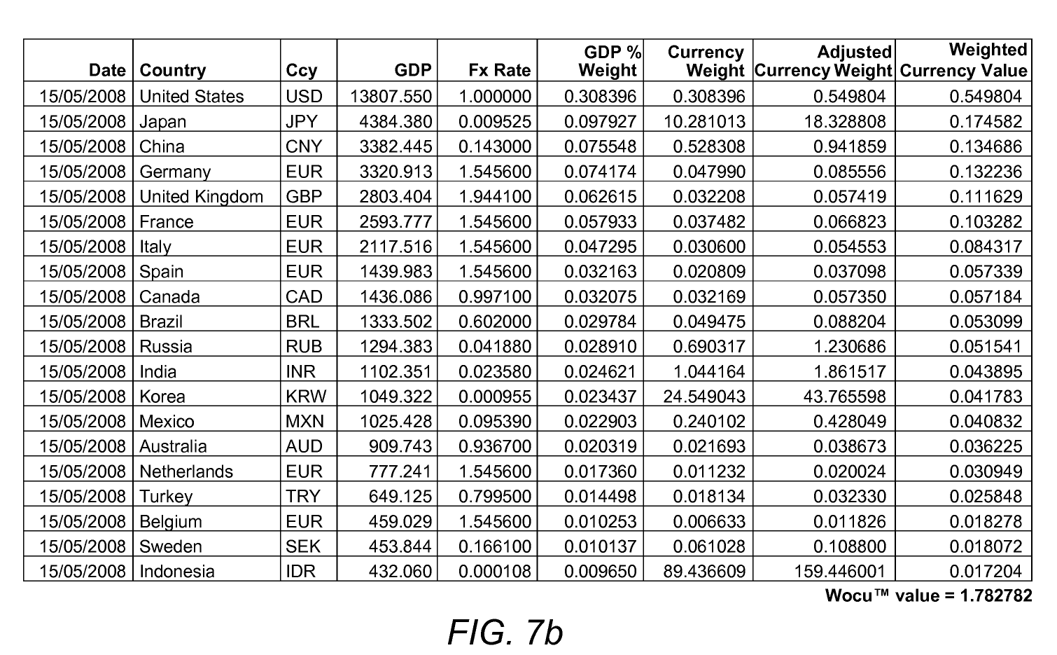

FIGS. 7a and 7b show an example of re-weighting which occurs when currency weightings are updated as a result of using: revised GDP values; the Wocu™ official value as at 16:00 UTC on the day of the re-weighting; and the forex spot mid rates for each component currency as at 16:00 UTC on the day of the re-weighting.

The table in FIG. 7a shows the current weightings as defined prior to the re-weighting event, while the table in FIG. 7b shows the revised weightings as defined after the re-weighting event carried out by the weighting process engine 2. In the case of this worked example, each country's currency is shown in the column entitled “Ccy”. The revised GDP values in US$ billions are shown in the column ‘GDP’ of FIG. 7b. The Wocu™ official value as at 16:00 UTC on the day of the re-weighting increased to 1.782782,and the forex spot mid rates for each component currency are shown in the column “FX Rate”. It can be seen that as a result of changes to GDP values associated with the twenty countries with the highest GDP values (which is to say, revised in relation to the values shown in FIG. 7a), the countries and hence the component currencies in the basket change.

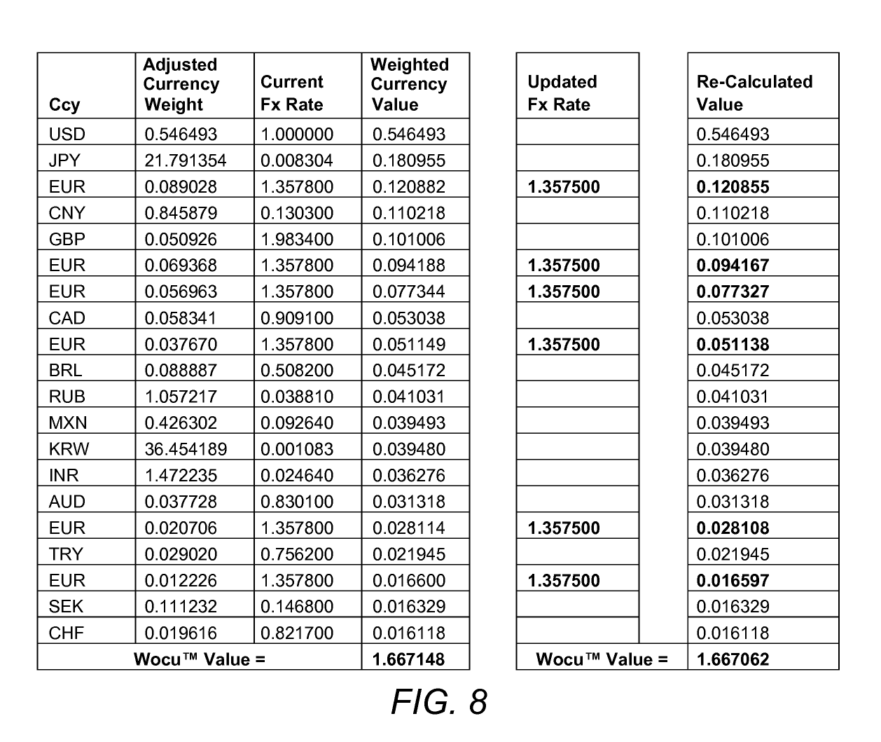

FIG. 8 shows an example of the output that is generated by the computer system 1 when a forex rate changes, as performed by the value calculation process engine 3. When a forex rate update occurs the current Wocu™ value is re-calculated and published. This re-calculation takes into account the latest forex rate received for all of the component currencies. In the table of FIG. 8 the forex rate for the Euro has updated from 1.357800 to 1.357500, resulting in a re-calculation of the value of the six Euro components, in turn resulting in a re-calculation of the Wocu™ value from 1.667148 to 1.667062.

As mentioned above, the global currency is a monetary and financial instrument and as such can form the basis of trading activities within the foreign exchange market, for example, in transactions involving spot, forwards, futures, swaps and options. To facilitate these activities, interest rates for the Wocu™ can be calculated on the basis of a composite of the interest rates of the currencies in the basket of countries. In one arrangement the computer system 1 can be further configured to receive data indicative of interest rates of a given country from a further external source feed (not shown) or from a data feed source 5 as shown in FIG. 2a, and, in response to changes thereto and/or according to a predetermined schedule, to calculate the Wocu™ interest rate on the basis of the following expressions:

Individual weighted currency interest rate=Component Currency Interest Rate*GDP Percentage Weight

SUM [Individual weighted currency interest rate]

The frequency with which the interest rates are calculated is, for example, daily at 16:00 UTC.

In one implementation of the components of the computer system 1, the software embodying the invention can be written in C++ and compiled using Microsoft Visual Studio version 6; the resulting executable programs can then run on servers running Microsoft Windows 2003 Server SP2, or higher.

More specifically, the Wocu™ Algorithm may be executed on a server providing four cores, 4 Gb RAM and 250 Gb Hard Disk Drive and running Microsoft Windows Server 2003 R2 Standard Edition version 5.2.R2 and Service Pack 2. The database server embodying the data store 6 may be MySQL version 5.1.37. To provide real-time forex rates and contingency against failure, the external data sources being utilized can be Morningstar Interactive data feed product and/or Interactive Data PlusFeed data feed product.

Those of skill will recognize that the various illustrative logical blocks, modules, circuits, and algorithm steps described in connection with the embodiments disclosed herein may be implemented as electronic hardware computer software or combinations of both. To clearly illustrate this interchangeability of hardware and software, various illustrative components, blocks modules, circuits, and steps have been described above generally in terms of their functionality. Whether such functionality is implemented as hardware or software depends upon the particular application and design constraints imposed on the overall system.

Skilled artisans may implement the described functionality in varying ways for each particular application, but such implementation decisions should not be interpreted as causing a departure from the scope of the present invention. The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CDROM, or any other form of storage medium known in the art. An exemplary storage medium is coupled to the processor such the processor can read information from and write information to, the storage medium. In the alternative, the storage medium may be integral to the processor.

The processor and the storage medium may reside in an ASIC. The ASIC may reside in a user terminal or some other type of device. In the alternative the processor and the storage medium may reside as discrete components in a user terminal.

The above embodiments are to be understood as illustrative examples of the invention. Further embodiments of the invention are envisaged. For example, the software components described can be distributed in one or more further computers, and the data store 6 and scheduled event store 8 may comprise a single data store, and could be implemented on a separate computer. Additionally, while the forex rate used in the calculation has been described as a mid price (the average of an ask and a bid price), the ask price only or the bid price only may be used for this purpose. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method for determining the value of a global currency, the method comprising:
using data indicative of a Gross Domestic Product (GDP) value of each of a plurality of countries to select a plurality of countries on the basis of a predetermined criterion;
evaluating relative weightings of the selected countries on the basis of their respective GDP values; and
combining said evaluated relative weightings with currency values associated with the selected countries so as to evaluate said global currency.

2. The method of claim 1, further comprising:
generating currency value data comprising an exchange rate for currencies associated with each of the selected countries, wherein each exchange rate is normalized against a base currency;
calculating a currency weighting for each currency value according to the GDP value of each selected country;
multiplying each normalized exchange rate by its respective currency weighting to determine a weighted currency value; and
summing the weighted currency values to determine the value of the global currency against the base currency.

3. The method of claim 2, further comprising the step of calculating, on the basis of the determined value for the global currency, the value of the global currency against one or more of the plurality of currencies associated with the selected countries using the respective exchange rate of each currency against the base currency.

4. The method of claim 2, wherein the step of calculating a currency weighting comprises:
summing the GDP values of the selected countries to determine a total GDP value;
determining a GDP percentage weight of the total GDP value for each selected country's GDP value;
determining, based on the GDP percentage weight and each currency exchange rate, respective currency weightings based on the currency of each selected country.

5. The method of claim 4, further comprising adjusting the currency weighting based on an adjustment value to provide an adjusted currency weighting, the adjustment value corresponding to a predetermined value of the global currency against the base currency.

6. The method of claim 5, further comprising:
generating data indicative of a change in the currency value data each time a change in the exchange rate occurs;
re-calculating the currency weighting in response to a change in the data indicative of the GDP value of the selected countries, said re-calculation using the data indicative of a change in the currency value at the time of the re-calculation; and
re-evaluating the global currency according to the re-calculated currency weighting.

7. The method of claim 5, wherein the currency weighting is re-calculated according to a predetermined schedule.

8. The method of claim 2, wherein generating the currency value data comprises:
receiving data indicative of an offer price of each currency against the base currency;
receiving data indicative of a bid price of each currency against the base currency; and
calculating a mid price value for each currency by averaging the respective offer and bid price data, whereby to generate the currency value.

9. The method of claim 8, wherein the selling and buying price data for at least some said currencies are received from an external data source, and said calculation of the mid price value is performed in response to changes in said selling and/or buying price data.

10. The method of claim 1, comprising the step of normalising the GDP values of the plurality of countries against a base currency, so as to allow selection of the plurality of countries on the basis of the predefined criterion.

11. The method of claim 1, wherein the predefined criterion on the basis of which the countries are selected is a predetermined number of countries having the largest GDP value.

12. The method of claim 1, wherein the predefined criterion on the basis of which the countries are selected is a threshold GDP percentage weight, above which threshold the country is selected.

13. A computer program, or a suite of computer programs, comprising a set of instructions which, when executed on a computer, or a suite of computers, is configured to perform the method of claim 1.

14. A currency evaluation system for determining the value of a global currency, the currency evaluation system comprising:
means for using data indicative of a Gross Domestic Product (GDP) value of each of a plurality of countries to select a plurality of countries on the basis of a predetermined criterion;
means for evaluating relative weightings of the selected countries on the basis of their respective GDP values; and
means for combining said evaluated relative weightings with currency values associated with the selected countries so as to evaluate said global currency.

15. The currency evaluation system of claim 14, comprising:
a value calculation engine configured to generate currency value data comprising an exchange rate for currencies associated with each of the selected countries, wherein each exchange rate is normalized against a base currency;
a weighting calculation engine configured to calculate a currency weighting for each currency value according to the GDP value of each selected country,
wherein the value calculation engine is configured to:
multiply each normalized exchange rate by its respective currency weighting to determine a weighted currency value; and
sum the weighted currency values to determine the value of the global currency against the base currency.

16. The currency evaluation system of claim 15, comprising one or more components configured to calculate, on the basis of the determined value for the global currency, the value of the global currency against one or more of the plurality of currencies associated with the selected countries using the respective exchange rate of each currency against the base currency.

17. The currency evaluation system of claim 15, wherein the weighting calculation engine is configured to:
sum the GDP values of the selected countries to determine a total GDP value;
determine a GDP percentage weight of the total GDP value for each selected country's GDP value; and
determine, based on the GDP percentage weight and each currency exchange rate, respective currency weightings based on the currency of each selected country.

18. The currency evaluation system of claim 17, wherein the weighting calculation engine is configured to adjust the currency weighting based on an adjustment value to provide an adjusted currency weighting, the adjustment value corresponding to a predetermined value of the global currency against the base currency.

19. The currency evaluation system of claim 18, wherein the value calculation engine is further configured to:
generate data indicative of a change in the currency value data each time a change in the exchange rate occurs; and
re-evaluate the global currency according to the re-calculated currency weighting,
wherein the weighting calculation engine is configured to re-calculate the currency weighting in response to a change in the data indicative of the GDP value of the selected countries on the basis of the data indicative of a change in the currency value generated by the value calculation engine that is current at the time of the re-calculation.

20. The currency evaluation system of claim 18, wherein the weighting calculation engine is adapted to re-calculate the currency weighting according to a predetermined schedule.

21. The currency evaluation system of claim 15, further comprising an interface arranged to receive data indicative of an offer price of each currency against the base currency and to receive data indicative of a bid price of each currency against the base currency, wherein the value calculation engine is adapted to calculate a mid price value for each currency by averaging the respective offer and bid price data, whereby to generate the currency value.

22. The currency evaluation system of claim 21, wherein the interface is configured to receive selling and buying price data of each currency from an external data source, and the value calculation engine is capable of performing said calculation of the mid price value in response to changes in said selling and/or buying price data.

23. The currency evaluation system of claim 14, further configured to normalize the GDP values of the plurality of countries against a base currency, so as to allow selection of the plurality of countries on the basis of the predefined criterion.

24. The currency evaluation system of claim 14, wherein the predefined criterion on the basis of which the countries are selected is a predetermined number of countries having the largest GDP value.

25. The currency evaluation system of claim 14, wherein the predefined criterion on the basis of which the countries are selected is a threshold GDP percentage weight, above which threshold the country is selected.

26. A computer-readable storage medium storing program code for causing a computer to perform:
using data indicative of a Gross Domestic Product (GDP) value of each of a plurality of countries to select a plurality of countries on the basis of a predetermined criterion;
evaluating relative weightings of the selected countries on the basis of their respective GDP values; and
combining said evaluated relative weightings with currency values associated with the selected countries so as to evaluate said global currency.

27. A currency evaluation system for determining the value of a global currency, the currency evaluation system comprising:
a first module configured to select a plurality of countries on the basis of a predetermined criterion using data indicative of a Gross Domestic Product (GDP) value of each of a plurality of countries;
a second module configured to evaluate relative weightings of the selected countries on the basis of their respective GDP values; and
a third module configured to combine the evaluated relative weightings with currency values associated with the selected countries so as to evaluate the global currency.
